(19) United States
(12) Patent Application Publication
(10) Pub. No.: US 2015/0024099 A1
(43) Pub. Date: Jan. 22, 2015

(54) METHOD FOR THE STERILIZATION AND PRESERVATION OF FOODSTUFFS

(71) Applicants: Hisaharu OKI, (US); Chokichi SATO, (US); Yukio MURATA, (US)

(72) Inventors: Hisaharu Oki, Sagamihara-shi (JP); Yukio Murata, Saitama-shi (JP)

(21) Appl. No.: 14/383,407

(22) PCT Filed: Mar. 11, 2013
(86) PCT No.: PCT/JP2013/057329

§ 371 Date: Sep. 5, 2014

(30) Foreign Application Priority Data
Mar. 9, 2012 (JP) 2012-053512

(51) Int. Cl. A23B 9/02; A23B 9/14; A23B 9/30

(52) U.S. Cl. CPC A23B 9/025; A23B 9/30; A23B 9/14; A23V 2002/00
USPC 426/310; 426/335; 426/331; 426/532

(57) ABSTRACT

Foodstuffs such as cereals, vegetables or fruits can be sterilized and disinfected by simple short-time processing for preservation of them over an extended period of time without recourse to substances harmful to human bodies, and prevention of growth of mold.

After a foodstuff is brought into contact with overheated steam having a temperature of 250° C. to 620° C., calcium oxide-containing powders are added to and mixed with it. The foodstuff may come into contact with overheated steam simultaneously with addition and mixing of the calcium oxide-containing powders.

The time of contact of the foodstuff with overheated steam is preferably 20 seconds to 0.5 second.

The calcium oxide-containing powders are preferably natural calcium oxide powders obtained by firing shells, coral, the nacreous layer, eggshells, or bones of animals, fishes or birds.

### FIELD OF THE ART

The present invention relates to a method for the sterilization and preservation of foodstuffs comprising sterilization and disinfection of microorganisms, insect pests, etc. deposited and present on foodstuffs such as cereals like beans, barely/wheat and rice, vegetables, fruits, and seafood whereby it is possible to preserve them over an extended period of time, and foodstuffs obtained by that method.

### BACKGROUND OF THE ART

In one example of conventional equipment for the sterilization and disinfection of foodstuffs or the like available in the art, it has been known to make use of overheated steam as disclosed typically in Patent Publication 1. Specifically, injection water is introduced into one side of a cylindrical unit filled with a member to be heated that comprises a plurality of spheres, etc., and that member is heated by high-frequency induction via an energized coil wound around the periphery of the cylindrical unit whereby high-temperature overheated steam is jetted out of the other side of the cylindrical unit. This high-temperature overheated steam is jetted onto foodstuffs or the like for sterilization and disinfection.

As disclosed in Patent Publication 2, there has also been a sterilization/disinfection method available in which high-temperature overheated steam (steam plasma) is instantaneously jetted onto cereals such as soybeans for sterilization and disinfection, said overheated steam generated by a steam plasma generator including an electrically conductive member to be heated and a coil that is wound around said conductive member and fed with high frequencies for electromagnetic induction heating of said conductive member.

In the meantime, there have been various methods proposed, inclusive of one for disinfecting or reducing microorganisms deposited on food materials such as cereals, beans, vegetables or seafood using an aqueous solution of hypochlorite.

For example, there has been a method proposed in which food materials such as cereals, beans, vegetables or seafood are processed in a flowing aqueous solution comprising water obtained by mixing ozone gas or oxygen gas into an aqueous solution of fired calcium having a pH value of 2.0 or more to actively increase OH radicals having disinfection action thereby reducing microorganisms sticking to them without detrimental to their taste and flavor (Patent Publication 3).

### PRIOR ART PUBLICATIONS

Patent Publication 1: International Publication 2004/068033 in pamphlet form
Patent Publication 2: Patent Publication 2010-214093
Patent Publication 3: JP(A) 2008-99653

### SUMMARY OF THE INVENTION

### Objects of the Invention

With the abovementioned sterilization/disinfection equipment using overheated steam, however, it was often impossible to achieve sufficient effects on sterilization and disinfection for the reason of overheated steam's instable temperatures and other reasons. When high-temperature overheated steam was jetted onto the material to be processed such as a foodstuff over some time to obtain sterilization/disinfection effects in a forcible manner, there was a problem arising in that the nutrients of the foodstuff or the like were denatured and broken down.

And once cereals, or the like sterilized with high-temperature overheated steam have been bodily stored under an aseptic condition in a container, bacteria and molds will grow and proliferate immediately upon exposure to the presence of a slight amount of moisture or some warm conditions.

This in turn will result in the growth of carcinogenic mycotoxins having very high toxicity such as mycotoxin and aflatoxin, rendering the processed foodstuffs inedible.

Nowadays cereals, etc. exported by way of high temperature-and-humidity environments prevailing in the Southeast Asian countries and the Latin-American countries—the countries exporting foodstuffs such as rice and soybeans do not pass inspections by importers for the reason of deposition of such bacteria and mycotoxins or other reasons, resulting in massive amounts of the foodstuffs being returned back to the exporters.

The situations being like this, an object of the present invention is to sterilize and disinfect large amounts of foodstuffs in a short time in such a way as to preserve them over an extended period of time.

### Means for Achieving the Objects

Thus, the present invention provides a method for the sterilization and preservation of foodstuffs, which are embodied as follows.
[1] A method for the sterilization and preservation of foodstuffs, characterized in that a foodstuff is brought into contact with overheated steam having a temperature of 250° C. to 620° C. after which calcium oxide-containing powders are added to and mixed with the foodstuff. It should be noted that temperatures of 250° C. or higher, and especially 300° C. or higher allow for sterilization of bacteria, etc. on the surface of the foodstuff in a very short time, and that overheated steam of 620° C. or higher is hazardous to handle and makes the steam generator costlier.
[2] A method for the sterilization and preservation of foodstuffs, characterized in that a foodstuff is brought into contact with overheated steam having a temperature of 250° C. to 620° C. simultaneously with addition and mixing of calcium oxide-containing powders to and with the foodstuff. The sterilization/dehydration action of calcium oxide allows for preservation of the foodstuff having its surface processed with overheated steam under aseptic and mold-free conditions over an extended period of time.
[3] A method for the sterilization and preservation of foodstuffs, characterized in that a foodstuff is brought into contact with overheated steam having a temperature of 250° C. to 620° C. for 20 seconds to 0.5 second after which calcium oxide powders are added to and mixed with the foodstuff. Contact of the foodstuff with overheated steam for 20 seconds to 0.5 second allows for sterilization of all bacteria on the surface of the foodstuff.
[4] A method for the sterilization and preservation of foodstuffs, characterized in that a foodstuff is brought into contact with overheated steam having a temperature of 250° C. to 620° C. for 20 seconds to 0.5 second simultaneously with addition and mixing of calcium oxide-containing powders to and with the foodstuff. It should be noted that overheated steam and calcium oxide (CaO) may be simultaneously in contact with the surface of the foodstuff.
[5] A method for the sterilization and preservation of foodstuffs, characterized in that a foodstuff is brought into contact with overheated steam having a temperature of 250° C. to 620° C. for 20 seconds to 0.5 second simultaneously with spraying and scattering of a calcium oxide-containing liquid on the foodstuff so that calcium oxide is uniformly added and deposited onto the surface of the foodstuff.
[6] A method for the sterilization and preservation of foodstuffs, characterized in that a foodstuff is brought into contact with overheated steam having a temperature of 250° C. to 620° C. for 20 seconds to 0.5 second after which a calcium oxide-containing liquid is sprayed and scattered on the foodstuff so that calcium oxide is uniformly added and deposited onto the surface of the foodstuff.
[7] A method for the sterilization and preservation of foodstuffs as recited in any one of the aforesaid [1] to
[6], characterized in that the foodstuff is at least one selected from vegetables, fruits, cereals, seafood, and meat.
[8] A method for the sterilization and preservation of foodstuffs as recited in any one of the aforesaid [1] to [7], characterized in that the calcium oxide-containing powders have an average particle diameter of 10 to 400 μm. It should be appreciated that a particle diameter of less than 10 μm is acceptable, but it makes production costlier, and that a particle diameter of greater than 400 μm makes an area for contact with the surface of the foodstuff smaller.
[9] A method for the sterilization and preservation of foodstuffs as recited in any one of the aforesaid [1] to [8], characterized in that the calcium oxide-containing powders contain an antibacterial agent, a disinfectant or a deodorant. Binding of CaO with CO₂ in the air prevents the sterilization effect from becoming slender, and keeps the foodstuff against generation of bad smells.
[10] A method for the sterilization and preservation of foodstuffs as recited in any one of the aforesaid [1] to [9], characterized in that the calcium oxide-containing powders are natural calcium oxide powders obtained by firing shells, coral, the nacreous layer, eggshells, or bones of animals, fishes or birds. CaO coming from shells, etc., because of being free from harmful metals, etc., is approved as food additives and safe enough to be eaten by human beings.
[11] A method for the sterilization and preservation of foodstuffs as recited in any one of the aforesaid [1] to [10], characterized in that the contact of the foodstuff with the calcium oxide-containing powders takes place by mixing and addition of 0.005 to 5.0 parts by weight of the calcium oxide-containing powders with and to 100 parts by weight of the foodstuff. CaO may produce a sterilization effect even in an amount of 0.005 part by weight, but will not boost up that effect in an amount of greater than 5.0 parts by weight, working against cost effectiveness.
[12] A method for the sterilization and preservation of foodstuffs as recited in any one of the aforesaid [1] to [10], characterized in that 0.005 to 5.0 parts by weight of the calcium oxide-containing powders having an average particle diameter of 10 to 200 μm are added to and mixed with 100 parts by weight of a cereal as the foodstuff. The condition is preferably provided for the processing of cereals.
[13] A method for the sterilization and preservation of foodstuffs as recited in any one of the aforesaid [1] to [12], characterized in that the contact of said foodstuff with overheated steam takes place by allowing said foodstuff fed from above an upright cylindrical unit and falling down through it to come in contact with overheated steam jetted out of an inner wall of said cylindrical unit. This method allows for processing in a very short (fall) time, which ensures that the foodstuff falls down in an overheated atmosphere so that the entire surface of the foodstuff comes in contact with overheated steam.
[14] A method for the sterilization and preservation of foodstuffs as recited in any one of the aforesaid [1] to [13], characterized in that a temperature of the overheated steam coming into contact with the foodstuff is 300° C. to 600° C.
[15] A method for the sterilization and preservation of foodstuffs as recited in any one of the aforesaid [1] to [14], characterized in that the foodstuff is any one selected from a group consisting of rice, barley/wheat, corn, peanuts, soybeans, fruits, fishes, shellfishes, and vegetables.
[16] A foodstuff processed by any one of the methods as recited in the aforesaid [1] to [15].

### Advantages of the Invention

According to the present invention, foodstuffs can be disinfected by just a simple short-time contact of them with high-temperature overheated steam, and then preserved over an extended period of time by the sterilizing and antibacterial power of the calcium oxide powders (or calcium hydroxide that is an aqueous solution thereof).

As a result, the export of cereals or like products from producing countries where they are produced and harvested under high temperature-and-humidity conditions as well as the import of them by importers may be done without losses caused as by disposal of products contaminated by bacteria, mycotoxins, etc.

The present invention also allows for storage of foods over an extended period of time, and makes some contribution to the solution of food problems in unseasonable weather-strapped years.

### BRIEF EXPLANATION OF THE DRAWING

FIG. 1 is a schematic view of the general arrangement of an overheated steam generator and a sterilization/disinfection apparatus.

### MODES FOR CARRYING OUT THE INVENTION

An overheated steam (occasionally including steam in a plasma state) generator according to the present invention includes an electrically conductive member to be heated, and a coil for heating the conductive member by electromagnetic induction, and steam flowing in the conductive member from one end is heated in it into high-temperature overheated steam (a part of which would be in an ionized plasma sate) which is jetted out of it from the other end.

The aforesaid member to be heated should be an electrically conductive member for the reason that it is to be heated by electromagnetic induction, and the overheated steam generated and coming into contact with a foodstuff is at a temperature of 250° C. to 850° C., preferably 250° C. to 620° C., and more preferably 300° C. to 600° C.

For this reason, the aforesaid member to be heated may be formed of a material capable of maintaining stability even at a temperature of 850° C. such as iron, stainless steel or copper. Use may also be made of carbon or silicon carbide.

The steam produced in a boiler or the like and flowing into the aforesaid apparatus from one end is heated by the aforesaid conductive member to 250° C. or higher, and preferably 300° C. or higher. Especially at temperatures of 250° C. or higher, and preferably 300° C. or higher the surface of the foodstuff could be disinfected and processed in a very short time without any internal denaturing of the foodstuff by heating.

It is to be noted that the high frequency used here has an output of preferably 30 kW or more.

For a processing chamber in the apparatus used for contact of the foodstuff with the overheated steam, it is preferable to use an upright cylindrical unit having an overheated steam inlet pipe attached to a hole extending through a part of the wall of the upright cylindrical unit (for instance, see U.S. Pat. No. 4,838,364 and the drawings annexed thereto).

It is then preferred that overheated steam jetted out of the inner wall of the cylindrical unit is injected onto, and comes into contact with, a foodstuff such as rice or soybean that is fed from an opening in the upper end of the cylindrical unit and falls down through it.

Use may also be made of a sterilization/disinfection apparatus of the type that, as disclosed in JP(A) 2010-42071, includes a transversely mounted cylindrical unit which has a transversely placed rotary screw blade and in which overheated steam is introduced. Then, the material to be processed (foodstuff) is introduced in that cylindrical unit from one end, and brought into contact with overheated steam so that the processed material (foodstuff) can be removed from the other end.

In one preferable embodiment of the invention, fired calcium may be dropped together with the foodstuff into, for instance, the aforesaid upright cylindrical unit from above or, alternatively, the processed foodstuff guided out of the lower end of the upright cylindrical unit may be added to and mixed with fired calcium.

### EXAMPLES

The present invention will now be explained specifically with reference to examples.

### Example 1 of Processing Peanut

(1)

Overheated steam of 400° C. was generated from an overheated steam generator set at a high frequency output of 30 kW and a frequency of 20 kHz.

In the meantime, an upright cylindrical unit was provided with an opening formed on the way, and the overheated steam was successively introduced and jetted from the opening into the cylindrical unit.

Then, the material to be processed or peanut was dropped from an upper end opening in the upright cylindrical unit down through it, during which peanut was brought in contact with and irradiated with overheated steam for 0.7 second.

It is here to be noted that this example was carried out using the “steam plasma generator and sterilization/disinfection apparatus” disclosed in U.S. Pat. No. 4,838,364.

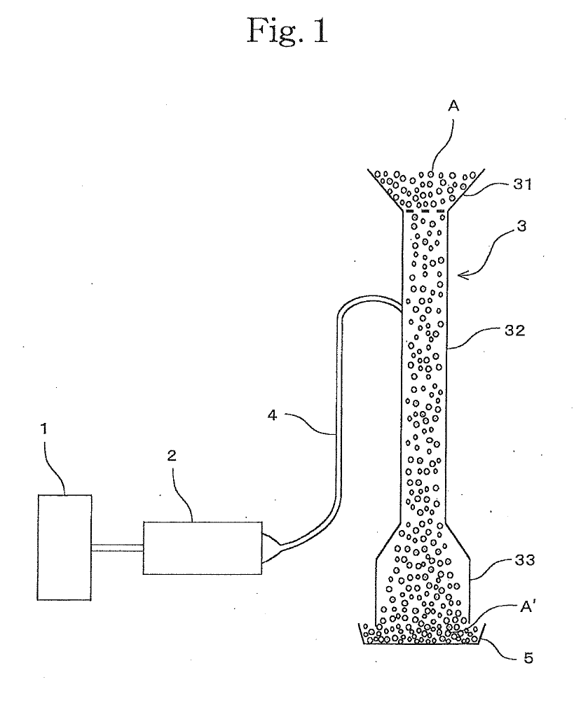

Referring more specifically to FIG. 1, steam generated in a steam boiler 1 is guided into an electromagnetic induction heating type overheated steam plasma generator 2, and the resulting overheated steam is introduced into a sterilization/disinfection chamber 3 by way of a feed pipe 4 for sterilization and disinfection.

It is here to be understood that the processing chamber 3 comprises a hopper 31, an upright cylindrical unit 32 and an outlet 33 for removing the processed foodstuff, and A, A′ and 5 stand for the foodstuff to be processed, the processed foodstuff, and a wire gauze receiver, respectively.

Then, peanuts subjected to the contact/irradiation processing with overheated steam was placed in a polyethylene bag in which fired calcium (composed mainly of CaO) powders obtained by firing coral fossils at 1,100° C. and having an average particle diameter of 80 μm were added and charged. The proportion of the powders to peanuts was 0.1% by weight. The polyethylene bag was shaken a few times to bring the fired calcium powders into contact with peanuts and hold them over peanuts.

The polyethylene bag filled up with peanuts was stored, while remaining unsealed, in an environment having a humidity of 80% and a temperature of 28° C. for 4 months.

(2)

Peanuts subjected to only the contact/irradiation processing with overheated steam in Example 1(1) was placed in a polyethylene bag which was in turn stored, while remaining unsealed, in an environment having a humidity of 80% and a temperature of 28° C. for 4 months.

(3)

Peanuts having the fired calcium powders merely added to and mixed with it, without being subjected to the contact/irradiation processing with overheated steam in Example 1(1), was placed in a polyethylene bag which was in turn stored, while remaining unsealed, in an environment having a humidity of 80% and a temperature of 28° C. for 4 months.

(4)

Further, peanuts, not subjected at all to the contact/irradiation processing with the overheated steam and the addition/mixing processing using the fired calcium powders in Example 1(1), was placed in a polyethylene bag which was in turn stored, while remaining unsealed, in an environment having a humidity of 80% and a temperature of 28° C. for 4 months.

From observations of peanut samples (1) to (4) after storage, it was found that there was none of bacteria and mold growing whatsoever on peanut sample (1) subjected to the contact/irradiation processing with overheated steam plus the addition/mixing processing using fired calcium powders.

On the other hand, there was a slight amount of mold and bacteria growing on peanut sample (2) subjected to only the contact/irradiation processing with overheated steam.

There was a slight amount of mold growing on peanut sample (3) subjected to the addition/mixing processing using fired calcium powders.

Further, peanut sample (4), not subjected at all to the irradiation processing with overheated steam plus the addition/mixing processing using fired calcium powders, was badly degraded in appearance, and there was a large amount of mold and bacteria growing as well.

In addition, the aforesaid peanut samples (1) to (4) were each placed in a polyethylene bag which was then stored, while remaining unsealed, in an environment having a humidity of 80% and a temperature of 28° C. for an additional 6 months or a total of 10 months.

As a result, there was neither mold nor bacteria observed at all on peanut sample (1′) stored for 10 months.

On the other hand, there were mold and bacteria growing on peanut sample (2′) stored for 10 months.

There were mold and bacteria growing on peanut sample (3′) subjected to only the addition/mixing processing using fired calcium powders and stored for 10 months.

Further, peanut sample (4′) (control 11), not subjected at all to the contact/irradiation processing with overheated steam plus the addition/mixing processing using fired calcium powders, was badly degraded in appearance, and there was a huge amount of mold and bacteria growing as well.

The foregoing results were summarized in Table 1 given later.

### Example 2 of Processing Wheat

(a)

As in Example 1(1), the contact/irradiation processing with overheated steam having a temperature of 400° C. and the addition/mixing processing using fired calcium powders were applied to wheat.

Then, the processed wheat was placed in a polyethylene bag which was in turn stored, while remaining unsealed, in an environment having a humidity of 80% and a temperature of 28° C. for 4 months.

(b)

Wheat subjected only to the contact/irradiation processing with overheated steam in Example 1(1) was placed in a polyethylene bag which was in turn stored, while remaining unsealed, in an environment having a humidity of 80% and a temperature of 28° C. for 4 months.

(c)

Further, wheat, subjected only to the addition/mixing processing using fired calcium powders and not subjected to the contact/irradiation processing with overheated steam in Example 1(1), was placed in a polyethylene bag which was in turn stored, while remaining unsealed, in an environment having a humidity of 80% and a temperature of 28° C. for 4 months.

(d)

And wheat, not subjected at all to the contact/irradiation processing with overheated steam and the addition/mixing processing fired calcium powders in Example 1(1), was placed in a polyethylene bag which was in turn stored, while remaining unsealed, in an environment having a humidity of 80% and a temperature of 28° C. for 4 months.

From observations of these wheat samples (a), (b), (c) and (d) after storage, there was none of mold found at all on sample (a) subjected to the irradiation processing with overheated steam plus the addition/mixing processing using fired calcium powders.

On the other hand, there was a slight amount of mold growing on wheat sample (b) subjected to only the contact/irradiation processing with overheated steam.

There was a slight amount of mold and bacteria growing on wheat sample (c) subjected to only the addition/mixing processing using fired calcium powders.

Further, wheat sample (d) (control 20), not subjected at all to the contact/irradiation processing with overheated steam plus the addition/mixing processing using fired calcium powders, was badly degraded in appearance, and there were mold and bacteria growing as well.

In addition, wheat samples (a) to (d) were each placed in a polyethylene bag while remaining unsealed, which was then stored in an environment having a humidity of 80% and a temperature of 28° C. for an additional 6 months or a total of 10 months.

As a result, there was neither mold nor bacteria observed at all on wheat sample (a′) stored for 10 months. On the other hand, there was bacteria growing on wheat sample (b′) stored for 10 months, and there was a small amount of mold and bacteria growing on wheat sample (c′) stored for 10 months. Further, wheat sample (d′) (control 21) stored for 10 months had an enormous amount of mold and bacteria growing, and there was severe degradation in appearance as well.

### Example 3 of Processing Lens Culinaris (Lentil)

### (A)

As in Example 1(1), the contact/irradiation processing with overheated steam having a temperature of 400° C. and the addition/mixing processing using fired calcium powders were applied to lentils.

Then, the processed lentils were placed in a polyethylene bag which was in turn stored, while remaining unsealed, in an environment having a humidity of 80% and a temperature of 28° C. for 4 months.

### (B)

Lentils subjected only to the contact/irradiation processing with overheated steam in Example 1(1) were placed in a polyethylene bag which was in turn stored, while remaining unsealed, in an environment having a humidity of 80% and a temperature of 28° C. for 4 months.

### (C)

Lentils, subjected only to the addition/mixing processing using fired calcium powders and not subjected to the contact/irradiation processing with overheated steam in Example 1(1), were placed in a polyethylene bag which was in turn stored, while remaining unsealed, in an environment having a humidity of 80% and a temperature of 28° C. for 4 months.

### (D)

Lentils, not subjected at all to the contact/irradiation processing with overheated steam and the addition/mixing processing fired calcium powders in Example 1(1), were placed in a polyethylene bag which was in turn stored, while remaining unsealed, in an environment having a humidity of 80% and a temperature of 28° C. for 4 months.

From observations of these lentil samples (A), (B), (C) and (D) after storage, there was none of mold observed at all on lentil sample (A) subjected to the irradiation processing with overheated steam plus the addition/mixing processing using fired calcium powders.

On the other hand, there was a slight amount of mold growing on lentil sample (B) subjected to only the contact/irradiation processing with overheated steam.

There were bacteria growing on lentil sample (C) subjected to only the addition/mixing processing using fired calcium powders.

Further, lentil sample (D) (control 30), not subjected at all to the contact/irradiation processing with overheated steam plus the addition/mixing processing using fired calcium powders, were badly degraded in appearance, and there were mold and bacteria growing as well.

In addition, lentil samples (A) to (D) were each placed in a polyethylene bag while remaining unsealed, which was then stored in an environment having a humidity of 80% and a temperature of 28° C. for an additional 6 months or a total of 10 months.

As a result, there was neither mold nor bacteria observed at all on lentil sample (A′) stored for 10 months. On the other hand, there were bacteria and mold growing on wheat sample (B′) stored for 10 months, and there were mold and bacteria growing on lentil sample (C′) stored for 10 months. Further, lentil sample (D′) (control 31) stored for 10 months had an enormous amount of mold and bacteria growing, and there was severe degradation in appearance.

### Example 4 of Processing Brown Rice

### (I)

As in Example 1(1), the contact/irradiation processing with overheated steam having a temperature of 400° C. and the addition/mixing processing using fired calcium powders were applied to brown rice.

Then, the processed brown rice was placed in a polyethylene bag which was in turn stored, while remaining unsealed, in an environment having a humidity of 80% and a temperature of 28° C. for 4 months.

### (II)

Brown rice subjected only to the contact/irradiation processing with overheated steam in Example 1(1) was placed in a polyethylene bag which was in turn stored, while remaining unsealed, in an environment having a humidity of 80% and a temperature of 28° C. for 4 months.

### (III)

Further, brown rice, subjected only to the addition/mixing processing using fired calcium powders and not subjected to the contact/irradiation processing with overheated steam in Example 1(1), was placed in a polyethylene bag which was in turn stored, while remaining unsealed, in an environment having a humidity of 80% and a temperature of 28° C. for 4 months.

### (IV)

And brown rice, not subjected at all to the contact/irradiation processing with overheated steam and the addition/mixing processing fired calcium powders in Example 1(1), was placed in a polyethylene bag which was in turn stored, while remaining unsealed, in an environment having a humidity of 80% and a temperature of 28° C. for 4 months.

From observations of these brown samples (I), (II), (III) and (IV) after storage, there was none of mold found at all on brown sample (I) subjected to the irradiation processing with overheated steam plus the addition/mixing processing using fired calcium powders.

On the other hand, there was a slight amount of bacteria growing on brown rice sample (II) subjected to only the contact/irradiation processing with overheated steam.

There was a slight amount of bacteria growing on brown rice sample (III) subjected to only the addition/mixing processing using fired calcium powders.

Further, brown rice sample (IV) (control 40), not subjected at all to the contact/irradiation processing with overheated steam and the addition/mixing processing using fired calcium powders, was badly degraded in appearance, and there were mold and bacteria growing as well.

In addition, brown rice samples (I) to (IV) were each placed in a polyethylene bag while remaining unsealed, which was stored in an environment having a humidity of 80% and a temperature of 28° C. for an additional 6 months or a total of 10 months.

As a result, there was neither mold nor bacteria observed at all on brown rice sample (I′) stored for 10 months. On the other hand, there were bacteria growing on brown rice sample (II') stored for 10 months, and there were mold and bacteria growing on brown rice sample (III′) stored for 10 months. Further, brown rice sample (IV′) (control 41) stored for 10 months had an enormous amount of mold and bacteria growing, and there was severe degradation in appearance as well.

In the examples of the invention, just only general living bacterial but also colon bacilli and spore-forming bacteria were not detected out of the foodstuffs 10 months, and even 24 months, after processing. According to the present invention, it is found that foodstuffs may be stored over an extended period of time of at least one year.

TABLE 1

| | Number of | | |
|---|---|---|---|
| | General Living | | |
| | Bacteria/g | Mold | Appearance |
| Example 1 | | | |
| (peanuts) | | | |
| (1) Overheated | 0 × 10 | Not found | Good |
| steam plus CaO | | | |
| (1′) Overheated | 0 × 10 | Not found | Good |
| steam plus CaO | | | |
| (2) Only | 1.5 × 10³ | Slightly found | Slightly |
| overheated | | | discolored |
| steam | | | |
| (2′) Only | 2.0 × 10⁴ | Found | Bad |
| overheated | | | |
| steam | | | |
| (3) Only CaO | 1.5 × 10³ | Not found | Good |
| (3′) Only CaO | 2.0 × 10⁵ | Slightly found | Bad |
| (4) Not | 1.2 × 10⁶ | Found | Bad |
| processed | | (mildew) | |
| (Control 10) | | | |
| (4′) Not | Unmeasurably | Large amount | Bad, |
| processed | enormous | (blue mold) | Unascertainable |
| (Control 11) | | | foodstuff shape |
| Example 2 | | | |
| (wheat) | | | |
| (a) Overheated | 0 × 10 | Not found | Good |
| steam plus CaO | | | |
| (a′) Overheated | 0 × 10 | Not found | Good |
| steam plus CaO | | | |
| (b) Only | 1.5 × 10³ | Not found | Good |
| overheated | | | |
| steam | | | |
| (b′) Only | 2.0 × 10⁴ | Slightly found | Bad |
| overheated | | (mildew) | |
| steam | | | |
| (c) Only CaO | 1.5 × 10³ | Not found | Good |
| (c′) Only CaO | 2.0 × 10³ | Slightly found | Bad |
| (d) Not | 1.2 × 10⁶ | Found | Bad |
| processed | | (blue mold) | |
| (Control 20) | | | |
| (d′) Not | Unmeasurably | Large amount | Bad |
| processed | enormous | (blue mold) | (bluish black) |
| (Control 21) | | | |
| Example 3 | | | |
| (Lentils) | | | |
| (A) Overheated | 0 × 10 | Not found | Good |
| steam plus CaO | | | |
| (A′) Overheated | 0 × 10 | Not found | Good |
| steam plus CaO | | | |
| (B) Only | 1.5 × 10³ | Slightly found | Slightly |
| overheated | | | discolored |
| steam | | | |
| (B′) Only | 2.0 × 10⁴ | Found | Bad |
| overheated | | | |
| steam | | | |
| (C) Only CaO | 1.5 × 10³ | Not found | Good |
| (C′) Only CaO | 2.0 × 10⁵ | Slightly | Bad |
| | | found | |
| (D) Not | 1.2 × 10⁶ | Found | Bad |
| processed | | (mildew) | |
| (Control 30) | | | |
| (D′) Not | Unmeasurably | Large amount | Bad, |
| processed | enormous | (blue mold) | Unascertainable |
| (Control 31) | | | foodstuff shape |
| Example 4 | | | |
| (brown rice) | | | |
| (I) Overheated | 0 × 10 | Not found | Good |
| steam plus CaO | | | |
| (I′) Overheated | 0 × 10 | Not found | Good |
| steam plus CaO | | | |
| (II) Only | 1.5 × 10³ | Not found | Good |
| overheated | | | |
| steam | | | |
| (II′) Only | 2.0 × 10⁴ | Slightly found | Bad |
| overheated | | | |
| steam | | | |
| (III) Only CaO | 1.5 × 10³ | Not found | Good |
| (III′) Only CaO | 2.0 × 10⁴ | Slightly found | Bad |
| (IV) Not | 1.5 × 10⁶ | Large amount | Bad (blue) |
| processed | | (blue mold) | |
| (Control 40) | | | |
| (IV) Not | Unmeasurably | Enormous | Bad |
| processed | enormous | amount | (bluish black) |
| (Control 41) | | (blue mold) | |

### APPLICABILITY TO THE INDUSTRY

The present invention makes it possible to preserve foodstuffs over an extended period of time without causing growth of bacteria and mold. The present invention can also prevent growth of mold itself to reduce damage from mycotoxins such as mycotoxin and aflatoxin in coincidental with growth of mold, extending the period of foodstuff preservation significantly and contributing much to the industry.

### EXPLANATION OF THE REFERENCE NUMERALS

1: Vapor boiler
2: Steam plasma generator
3: Sterilization/disinfection chamber
4: Overheated steam feed pipe
5: Metal gauze receiver
31: Hopper
32: Upright cylindrical unit
33: Outlet

1. A method for sterilization and preservation of foodstuffs, characterized in that a foodstuff is brought into contact with overheated steam having a temperature of 250° C. to 620° C. after which calcium oxide-containing powders are added to and mixed with said foodstuff.

2. A method for sterilization and preservation of foodstuffs, characterized in that a foodstuff is brought into contact with overheated steam having a temperature of 250° C. to 620° C. simultaneously with addition and mixing of calcium oxide-containing powders to and with said foodstuff.

3. A method for sterilization and preservation of foodstuffs, characterized in that a foodstuff is brought into contact with overheated steam having a temperature of 250° C. to 620° C. for 20 seconds to 0.5 second after which calcium oxide-containing powders are added to and mixed with said foodstuff.

4. A method for sterilization and preservation of foodstuffs, characterized in that a foodstuff is brought into contact with overheated steam having a temperature of 250° C. to 620° C. for 20 seconds to 0.5 second simultaneously with addition and mixing of calcium oxide-containing powders to and with said foodstuff.

5. A method for sterilization and preservation of foodstuffs, characterized in that a foodstuff is brought into contact with overheated steam having a temperature of 250° C. to 620° C. for 20 seconds to 0.5 second simultaneously with spraying and scattering of a calcium oxide-containing liquid on said foodstuff so that calcium oxide is uniformly added and deposited onto a surface of the foodstuff

6. A method for sterilization and preservation of foodstuffs, characterized in that a foodstuff is brought into contact with overheated steam having a temperature of 250° C. to 620° C. for 20 seconds to 0.5 second after which a calcium oxide-containing liquid is sprayed and scattered on said foodstuff so that calcium oxide is uniformly added and deposited onto a surface of said foodstuff.

7. A method for sterilization and preservation of foodstuffs as recited in claim 1, characterized in that said foodstuff is at least one selected from vegetables, fruits, cereals, seafood, and meat.

8. A method for sterilization and preservation of foodstuffs as recited in claim 1, characterized in that said calcium oxide-containing powders have an average particle diameter of 10 to 400·m.

9. A method for sterilization and preservation of foodstuffs as recited in claim 1, characterized in that the calcium oxide-containing powders contain an antibacterial agent, a disinfectant or a deodorant.

10. A method for sterilization and preservation of foodstuffs as recited in claim 1, characterized in that said calcium oxide-containing powders are natural calcium oxide powders obtained by firing shells, coral, the nacreous layer, eggshells, or bones of animals, fishes or birds.

11. A method for sterilization and preservation of foodstuffs as recited in claim 1, characterized in that contact of said foodstuff with said calcium oxide-containing powders takes place by mixing and addition of 0.005 to 5.0 parts by weight of said calcium oxide-containing powders with and to 100 parts by weight of said foodstuff.

12. A method for sterilization and preservation of foodstuffs as recited in claim 1, characterized in that 0.005 to 5.0 parts by weight of said calcium oxide-containing powders having an average particle diameter of 10 to 200 □m are added to and mixed with 100 parts by weight of a cereal as said foodstuff

13. A method for sterilization and preservation of foodstuffs as recited in claim 1, characterized in that contact of said foodstuff with overheated steam takes place by allowing said foodstuff fed from above an upright cylindrical unit and falling down through it to come in contact with overheated steam jetted out of an inner wall of said cylindrical unit.

14. A method for sterilization and preservation of foodstuffs as recited in claim 1, characterized in that a temperature of said overheated steam coming into contact with said foodstuff is 300° C. to 600° C.

15. A method for sterilization and preservation of foodstuffs as recited in claim 1, characterized in that said foodstuff is any one selected from a group consisting of rice, barley/wheat, corn, peanuts, soybeans, fruits, fishes, shellfishes, and vegetables.

16. A foodstuff processed by any one of the methods as recited in claim 1.
